(19) United States
(12) Patent Application Publication
(10) Pub. No.: US 2026/0360591 A1
(43) Pub. Date: Nov. 12, 2026

(54) HARNESS BRANCHING APPARATUS

(71) Applicant: Yazaki Corporation, Tokyo (JP)

(72) Inventors: Toshiaki Anzai, Shizuoka (JP); Tomoki Hayashi, Shizuoka (JP)

(21) Appl. No.: 19/645,500

(22) Filed: Apr. 13, 2026

(30) Foreign Application Priority Data
May 9, 2025 (JP) 2025-078638

(51) Int. Cl. H01B 13/012

(52) U.S. Cl. CPC H01B 13/01236; H01B 13/01281

(57) ABSTRACT

A harness branching apparatus includes: an electric wire holding section configured to hold connectors of unbranched connector-combined electric wires in an state; a connector pulling-up mechanism configured to pull up a plurality of target connectors from the electric wire holding section and to hold the target connectors; and a branching mechanism configured to gather and bundle electric wires suspended from the target connectors to bring the electric wires together in a concentration position to form a branching target point, wherein the connector pulling-up mechanism includes: connector chucks; and a chuck conveying mechanism configured to move a plurality of target connector chucks of the connector chucks downward to allow each of the target connector chucks to grip one of the target connectors and to move each of the target connectors upward by a distance corresponding to the branched form.

### BACKGROUND OF THE INVENTION

### Technical Field

The present invention relates to a harness branching apparatus configured to form one or more branch junction points for defining a branched form of a wire harness.

### Background Art

Conventionally, it is known that a connector-combined electric wire is routed on a wiring board and e.g. various exterior surrounding elements are attached to produce a wire harness, wherein the connector-combined electric wire has been previously produced e.g. by inserting terminals of terminal-combined electric wires into connectors (see e.g. Patent Document 1). According to the Patent Document 1, an unbranched connector-combined electric wire is placed on a wiring board and routed, wherein electric wires of the connector-combined electric wire are then bundled e.g. by means of a tape to form a branch junction point for defining a branched form.

### CITATION LIST

### Patent Literature

Patent Document 1: JP 2001-319531 A

### SUMMARY OF THE INVENTION

In a branching process of the unbranched connector-combined electric wire by routing it on the wiring board, for example sorting and routing operations of the separated electric wires on the wiring board tend to require many resources, which may result in burdens on an operator during production of the wire harness. Therefore, an apparatus is desired which enables a branch junction point to be formed without performing a routing process on a wiring board, the branch junction point defining a branched form of a wire harness.

Therefore, the present invention is focused on the above-described problem, and an objective of the present invention is to provide a harness branching apparatus which enables a branch junction point to be formed without performing a routing process on a wiring board, the branch junction point defining a branched form of a wire harness.

In order to achieve the above-described objective, a harness branching apparatus includes: an electric wire holding section configured to hold one or more connector-combined electric wires in an unbranched state, the one or more connector-combined electric wires including a plurality of connectors and electric wires interconnected between the plurality of connectors, wherein the one or more connector-combined electric wires have been produced in a pre-process for producing a wire harness having a branched form with one or more branch junction points, wherein the electric wire holding section is configured to hold the plurality of connectors aligned horizontally in line in a direction of arrangement for holding the one or more connector-combined electric wires in the unbranched state, wherein the direction of arrangement intersects a direction of gravity; a connector pulling-up mechanism configured to pull up a plurality of target connectors connected to ends of electric wires leading to a branching target point, upward from the electric wire holding section along the direction of gravity by a distance corresponding to the branched form and to hold the plurality of target connectors, the plurality of target connectors being included the plurality of connectors, wherein the branching target point is one of the branch junction points that are intended to define the branched form when the wire harness is completed; and a branching mechanism configured to gather and bundle electric wires suspended from the plurality of target connectors respectively to form the branching target point, wherein the electric wires suspended from the plurality of target connectors are gathered in a direction of concentration so that the electric wires are brought together in the direction of gravity in a concentration position corresponding to the branching target point, and wherein the direction of concentration extends along the direction of arrangement, wherein the connector pulling-up mechanism includes: a predetermined number of connector chucks aligned horizontally in line in the direction of arrangement above the electric wire holding section along the direction of gravity, each of the connector chucks being movable along the direction of gravity, wherein the predetermined number is larger than one, wherein each of the connector chucks is configured to hold one gripped connector in a direction of gripping to be rotatable around an axis of rotation extending along the direction of gripping, wherein the direction of gripping intersects both the direction of arrangement and the direction of gravity; and a chuck conveying mechanism configured to hold the connector chucks aligned in horizontally in line in the direction of arrangement so that the connector chucks are individually conveyable in the direction of gravity, wherein the plurality of connector chucks includes a plurality of target connector chucks each of which is associated with one of the plurality of target connectors, wherein the chuck conveying mechanism is further configured to move the plurality of target connector chucks downward to allow each of the plurality of target connector chucks to grip an associated one of the plurality of target connectors and to move each of the plurality of target connectors upward by a distance corresponding to the branched form.

The above-described harness branching apparatus enables a branch junction point to be formed without performing a routing process on a wiring board, the branch junction point defining a branched form of a wire harness.

### BRIEF DESCRIPTION OF THE DRAWINGS

FIG. 1 shows a perspective view of a harness branching apparatus according to an embodiment;

FIG. 2 schematically shows an input and an output of the harness branching apparatus as shown in FIG. 1 that are shown in series;

FIG. 3 shows an electric wire holding section as shown in FIG. 1 removed out of the harness branching apparatus;

FIG. 4 shows an enlarged view of one of a plurality of connector chucks as shown in FIG. 1;

FIG. 5 shows an enlarged view of a branching mechanism as shown in FIG. 1;

FIG. 6 schematically shows a pair of first clamping members and a pair of second clamping members as shown in FIG. 5 before sliding in a direction of concentration;

FIG. 7 schematically shows the pair of first clamping members and the pair of second clamping members as shown in FIG. 5 after sliding in the direction of concentration;

FIG. 8 schematically shows a first step S11 and a second step S12 of a series of operations for forming a branching target point which are carried out under control of a controller as shown in FIG. 1;

FIG. 9 schematically shows a third step S13 and a fourth step S14 of the series of operations for forming the branching target point that follow operations as shown in FIG. 8; and

FIG. 10 schematically shows a fifth step S15 and a sixth step S16 of the series of operations for forming the branching target point that follow operations as shown in FIG. 9.

### DETAILED DESCRIPTION OF THE PREFERRED EMBODIMENTS

Hereinafter, an embodiment of a harness branching apparatus will be described.

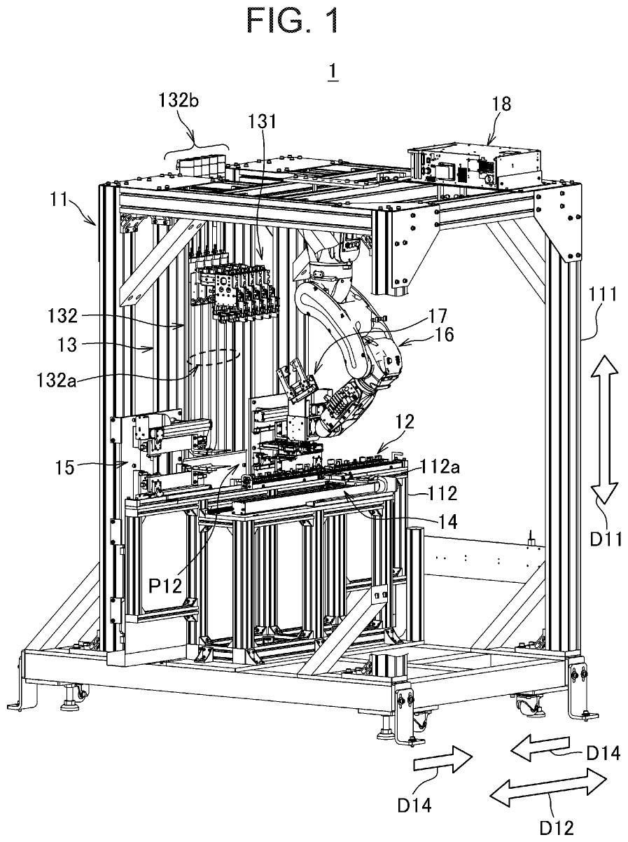

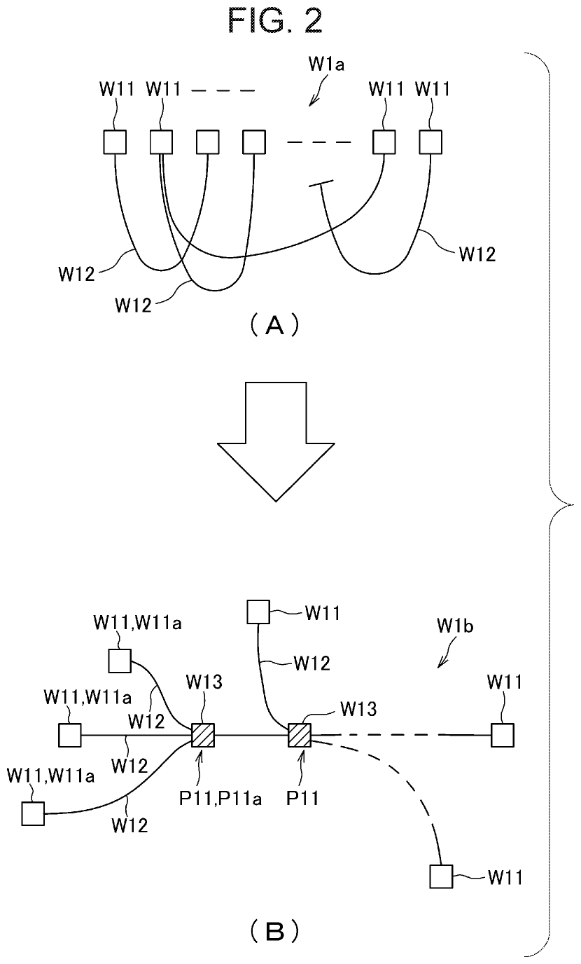

FIG. 1 shows a perspective view of a harness branching apparatus according to an embodiment. FIG. 2 schematically shows an input and an output of the harness branching apparatus as shown in FIG. 1 that are shown in series. It is to be noted that FIG. 1 shows the harness branching apparatus 1 including a frame 11, wherein the frame 11 is shown as being partially removed for the sake of better understanding with respect to an internal structure of the harness branching apparatus 1. FIG. 2 schematically shows an exemplary input of the harness branching apparatus 1 in (A) and an exemplary output of the harness branching apparatus 1 in (B).

For the harness branching apparatus 1 according to the present embodiment, an unbranched connector-combined electric wire W1a is set as an input provided to the harness branching apparatus 1, wherein FIG. 2 shows an example of the unbranched connector-combined electric wire W1a in (A). This unbranched connector-combined electric wire W1a has been produced in a pre-process to produce a wire harness having a branched form with one or more branch junction points P11. The unbranched connector-combined electric wire W1a includes a plurality of connectors W11 and electric wires W12 interconnected between the plurality of connectors W11. Such an unbranched connector-combined electric wire W1a is set in the harness branching apparatus 1, in which a branching process is performed through internal automatic mechanical operation.

Then, a branched connector-combined electric wire W1b is formed as an output of the harness branching apparatus 1, wherein FIG. 2 shows an example of the branched connector-combined electric wire W1a in (B). The branched connector-combined electric wire W1b includes the branch junction points P11 defining a branched form of the wire harness, wherein the branch junction points P11 are formed by bundling the electric wires W12 via wrapping tapes as bundling members W13 around the electric wires W12. The harness branching apparatus 1 according to the present embodiment is configured to form such branch junction points P11 individually one by one.

It is to be noted that the branched connector-combined electric wire W1b as the output of this harness branching apparatus 1 may be a complete wire harness as a final product, or one or more additional exterior surrounding elements may be attached to complete a wire harness.

The harness branching apparatus 1 according to the present embodiment includes a frame 11, an electric wire holding section 12, a connector pulling-up mechanism 13, a connector positioning mechanism 14, a branching mechanism 15, a robotic arm 16, a post-branching holding mechanism 17, and a controller 18.

The frame 11 includes an outer frame 111 and an inner frame 112, the outer frame 111 having a rectangular parallelepiped appearance and being formed e.g. by combined metal squared beams, wherein the inner frame 112 is constructed inside the outer frame 111 and includes internal mechanism sections such as the electric wire holding section 12 and the connector pulling-up mechanism 13 mounted to the inner frame 112. The robotic arm 16 is attached to a ceiling portion of the outer frame 111 so as to be suspended toward the inside of the outer frame 111 from the ceiling portion. The controller 18 is provided on an upper surface of the ceiling portion.

The electric wire holding section 12 is provided on the inner frame 112 and configured to hold the unbranched connector-combined electric wire W1a, wherein FIG. 2 shows an example of the unbranched connector-combined electric wire W1a in (A).

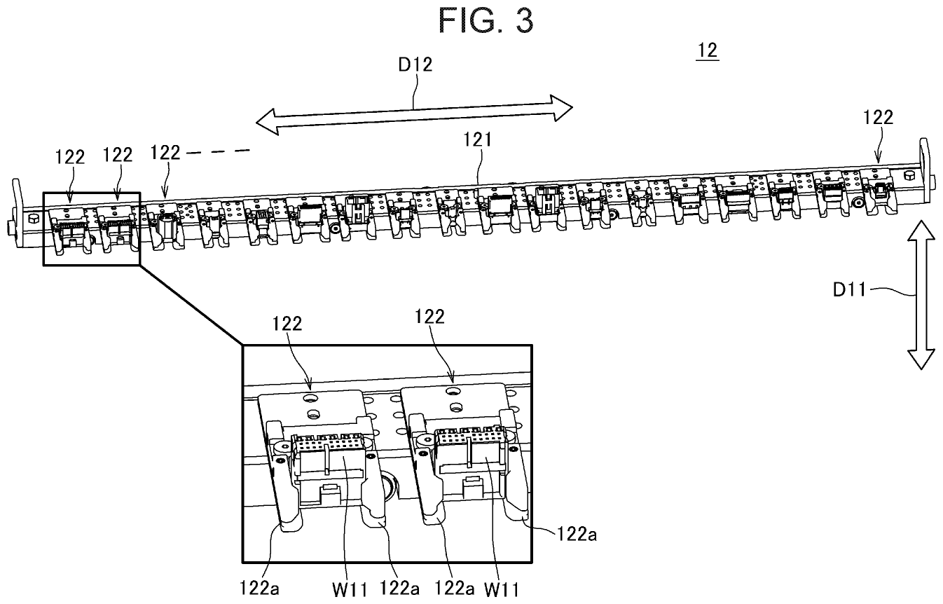

FIG. 3 shows the electric wire holding section as shown in FIG. 1 removed out of the harness branching apparatus. It is to be noted that FIG. 3 shows the electric wire holding section 12 with an orientation in which the plurality of connectors W11 held by the electric wire holding section 12 is shown on the front side in FIG. 3. In contrast, FIG. 1 shows the electric wire holding section 12 of the harness branching apparatus 1 with an orientation opposite to that in FIG. 3 in which the plurality of connectors W11 is oriented to the rear left side in FIG. 1. It is further to be noted that the electric wires W12 suspended from the plurality of connectors W11 are omitted for better understanding.

In order to hold the unbranched connector-combined electric wire W1a, the electric wire holding section 12 holds the plurality of connectors W11 aligned horizontally in line in a direction of arrangement D12 intersecting a direction of gravity D11. The electric wire holding section 12 includes a strip-shaped holding section main body 121 and a plurality of holding chucks 122, the holding section main body 121 extending in the direction of arrangement D12, wherein the plurality of holding chucks 122 is fixed to the holding section main body 121 so as to be aligned horizontally in line. Each of the holding chucks 122 holds one of the connectors W11 by means of a pair of arms 122a so that one or more electric wires W12 are suspended downward from the connector W11 in the direction of gravity D11. Furthermore, the electric wire holding section 12 is provided on a slide rail 112a at the inner frame 112 of the frame 11 so as to be slidable on the slide rail 112a along the direction of arrangement D12 in which the plurality of connectors W11 is arranged.

Next, the connector pulling-up mechanism 13 shown in FIG. 1 is configured to pull up a plurality of target connectors upward in the direction of gravity D11, wherein the plurality of target connectors is included in the plurality of connectors W11 held by the electric wire holding section 12. The plurality of target connectors refers to connectors W11 connected to ends of electric wires W12 leading to a branching target point, wherein the branching target point is one of the branch junction points P11 that are intended to define the branched form when the wire harness is completed. This will be described with reference to the example shown in FIG. 2. For example, one of two branch junction points P11 shown in FIG. 2 which is shown on the left side in FIG. 2 shall be a branching target point P11a. In this case, three connectors W11 connected to ends of electric wires W12 leading to this one branching target point P11a are selected as target connectors W11a. The connector pulling-up mechanism 13 then pulls up and holds the plurality of target connectors W11a by a distance corresponding to the branched form, i.e., by a distance corresponding to an electric wire length, wherein the electric wire length extends from the target connector W11a to the branching target point P11a when the wire harness is completed. The connector pulling-up mechanism 13 includes a plurality of connector chucks 131 and a chuck conveying mechanism 132.

A predetermined number of connector chucks 131 (the predetermined number is five in the example as shown in FIG. 1) is aligned horizontally in line in the direction of arrangement D12 above the electric wire holding section 12 along the direction of gravity D11, each of the connector chucks 131 being movable along the direction of gravity D11.

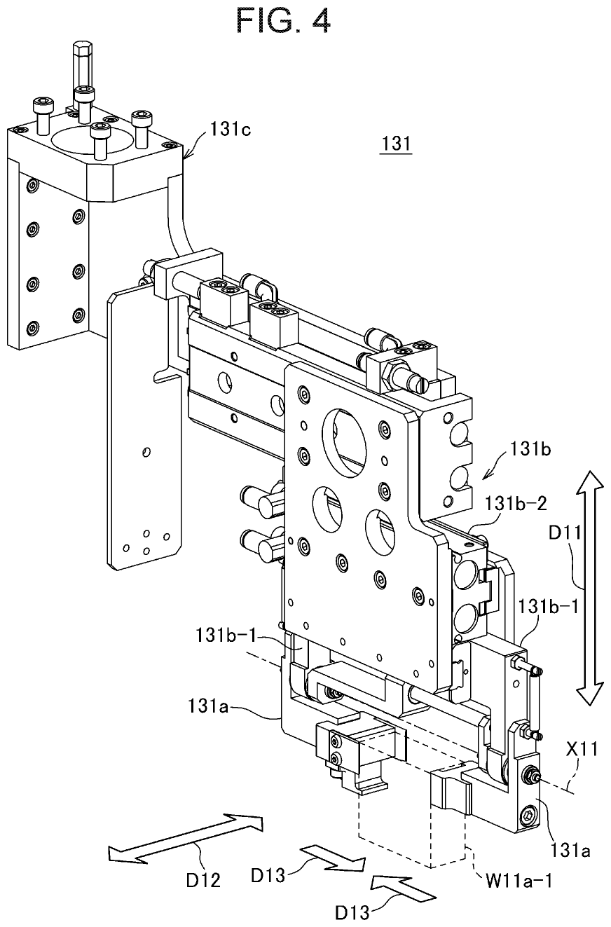

FIG. 4 shows an enlarged view of one of the plurality of connector chucks as shown in FIG. 1.

Each of the connector chucks 131 is configured to hold one gripped connector W11a-1 in a direction of gripping D13 to be rotatable around an axis of rotation X11 extending along the direction of gripping D13, wherein the direction of gripping D13 intersects both the direction of arrangement D12 and the direction of gravity D11. Each of the connector chucks 131 includes a pair of chuck arms 131a, an arm driving section 131b, and a conveyance held section 131c.

Each of the pair of chuck arms 131a is formed in a L-shape, wherein the pair of chuck arms 131a is configured to grip the gripped connector W11a-1 between tips of portions of the chuck arms 131a corresponding to a horizontal line of the L-shape. The arm driving section 131b includes a pair of intercoupling members 131b-1, wherein a portion of each of the pair of chuck arms 131a corresponding to a vertical line of the L-shape is held by one of the pair of intercoupling members 131b-1 to be rotatable around the axis of rotation X11. Then, the pair of chuck arms 131a are moved in the direction of gripping D13 via the pair of intercoupling members 131b-1 to grip and release the gripped connector W11a-1.

The arm driving section 131b holds the pair of chuck arms 131a via the above-mentioned pair of intercoupling members 131b-1. Then, the arm driving section 131b causes the pair of chuck arms 131a to grip and release the gripped connector W11a-1 by moving the intercoupling members 131b-1 with a driving force exerted by the driving source 131b-2.

The conveyance held section 131c is configured to be held by the chuck conveying mechanism 132 shown in FIG. 1 and conveyed in the direction of gravity D11.

The chuck conveying mechanism 132 shown in FIG. 1 is hold the plurality of connector chucks 131 aligned horizontally in line in the direction of arrangement D12 so that the plurality of connector chucks 131 are individually conveyable in the direction of gravity D11. The plurality of connector chucks 131 include a plurality of target connector chucks each of which is associated with one of the plurality of target connectors W11a, wherein the chuck conveying mechanism 132 is configured to move the plurality of target connector chucks downward to allow each of the plurality of target connector chucks to grip an associated one of the plurality of target connectors W11a. The chuck conveying mechanism 132 is further configured to individually move each of the plurality of target connectors W11a upward by a distance corresponding to the branched form. This chuck conveying mechanism 132 includes a plurality of conveyance holding sections 132a and a driving section 132b.

Each of the plurality of conveyance holding sections 132a is configured to hold one of the connector chucks 131 so that the connector chucks 131 is conveyable in the direction of gravity D11. According to the present embodiment, conveyer belts are employed for the conveyance holding sections 132a, wherein the conveyor belts are moved upward and downward in the direction of gravity D11. The conveyance held section 131c of each of the plurality of connector chucks 131 is individually coupled to one of the plurality of conveyance holding sections 132a.

The driving section 132b is a driving source such as a motor that is configured to provide a driving force to the plurality of conveyance holding sections 132a to cause the plurality of conveyance holding sections 132a to convey the connector chucks 131 in the direction of gravity D11.

Next, the connector positioning mechanism 14 is configured to move the electric wire holding section 12 slidingly that is provided to be slidable on the slide rail 112a of the inner frame 112. The connector positioning mechanism 14 is configured to move the electric wire holding section 12 slidingly along the direction of arrangement D12 prior to downward movement of the plurality of target connector chucks of the plurality of connector chucks 131 to the plurality of target connectors W11a. The connector positioning mechanism 14 positions each of the plurality of target connectors W11a below one of the plurality of target connector chucks. via the sliding movement. The plurality of target connector chucks is moved downward to the plurality of target connectors W11a thus positioned and grips them.

The branching mechanism 15 is configured to form the branching target point P11a for electric wires W12 suspended from the plurality of target connectors respectively that have been pulled up by the connector pulling-up mechanism 13. The branching mechanism 15 is configured to gather and bundle the electric wires W12 in a direction of concentration D14 so that the electric wires W12 are brought together in the direction of gravity D11 in a concentration position P12 corresponding to the branching target point P11a to form the branching target point P11a, wherein the direction of concentration D14 extends along the direction of arrangement D12.

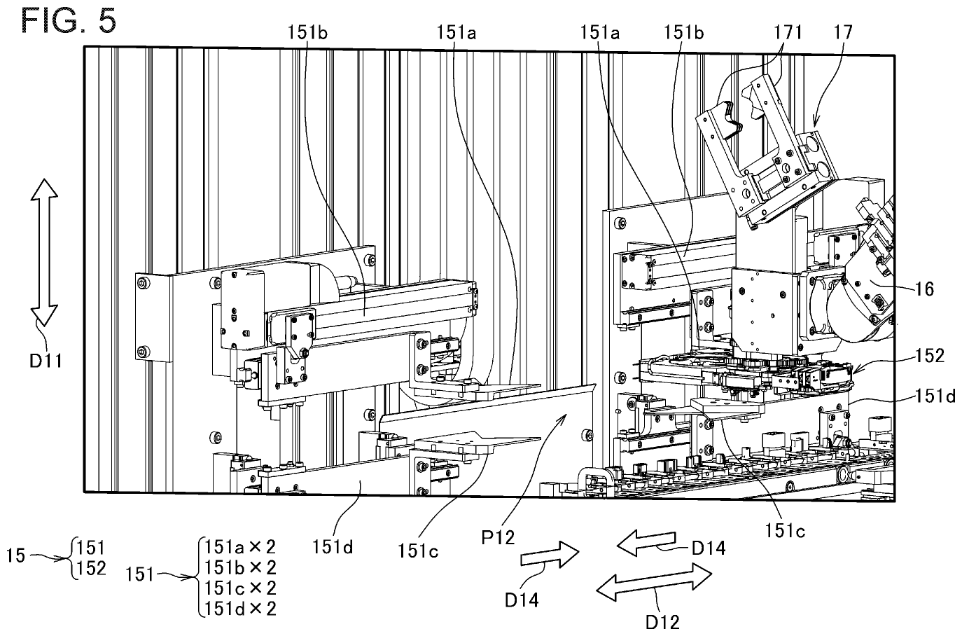

FIG. 5 shows an enlarged view of the branching mechanism as shown in FIG. 1.

The branching mechanism 15 includes a concentration mechanism 151 and a bundling mechanism 152 to form the branching target point P11a in the concentration position P12.

The concentration mechanism 151 is configured to initiate gathering the electric wires W12 in the direction of concentration D14 at a point of time between start and end of a pulling-up process of the plurality of target connectors by the connector pulling-up mechanism 13 so that the electric wires W12 are brought together in the concentration position P12. This concentration mechanism 151 includes a pair of first clamping members 151a, a pair of first clamping driving sections 151b, a pair of second clamping members 151c, and a pair of second clamping driving sections 151d.

The pair of first clamping members 151a is a pair of plate members that is arranged above the concentration position P12 in the direction of gravity D11, wherein the pair of plate members is configured to gather the electric wire W12 extending from the plurality of target connectors so as to clamp the electric wires W12 in the direction of concentration D14. The pair of first clamping driving sections 151b is configured to move the pair of first clamping members 151a slidingly in the direction of concentration D14. The pair of second clamping members 151c is arranged below the concentration position P12 in the direction of gravity D11 and configured to gather the electric wire W12 extending from the plurality of target connectors so as to clamp the electric wires W12 in the direction of concentration D14. The pair of second clamping driving sections 151d is configured to move the pair of second clamping members 151c slidingly in the direction of concentration D14 and to move the pair of second clamping members 151c downward along the direction of gravity D11 as described below.

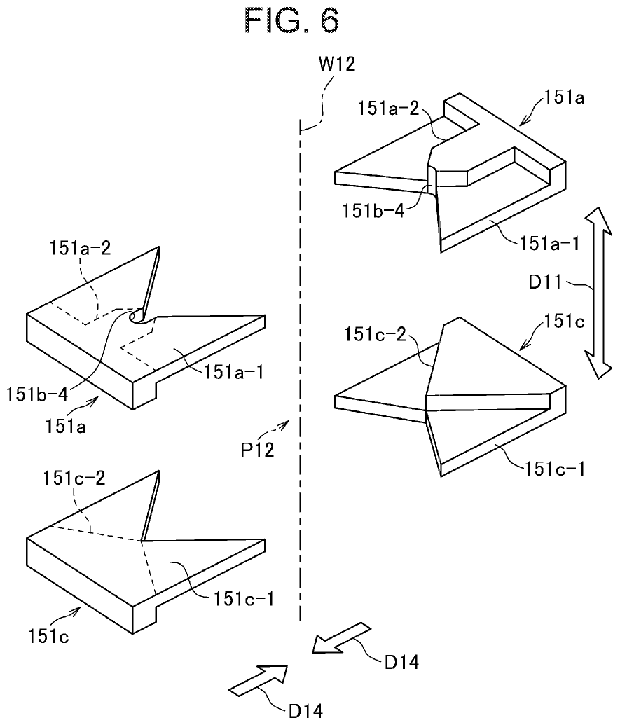

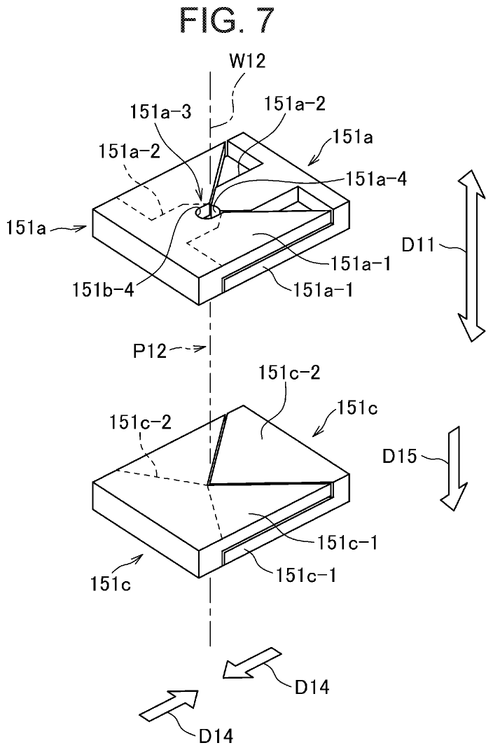

FIG. 6 schematically shows the pair of first clamping members and the pair of second clamping members as shown in FIG. 5 before sliding in the direction of concentration. FIG. 7 schematically shows the pair of first clamping members and the pair of second clamping members as shown in FIG. 5 after sliding in the direction of concentration. It is to be noted that in FIGS. 6 and 7, the electric wires W12 to be gathered in the direction of concentration D14 by means of the pair of first clamping driving sections 151b and the pair of second clamping members 151c are schematically shown with a single dash-dotted line.

The pair of first clamping members 151a is plate members having a same shape, wherein the electric wire W12 are placed between the first clamping members 151a, and the first clamping members 151a are inverted to each other with respect to the electric wire W12. Each of the first clamping members 151a includes a first indented portion 151a-1 and a first projecting portion 151a-2 that are overlapped with each other in a plate thickness direction and integrated with each other. The first indented portion 151a-1 is formed in a plate shape with a V-shaped recess. The first projecting portion 151a-2 is formed in a V-shaped projecting shape that is fitted into the first indented portion 151a-1 of the other first clamping member 151a. Furthermore, each of the first clamping members 151a includes a notch 151a-4 formed therein at a deepest point in the V-shape, wherein the notch 151a-4 defines a through hole 151a-3 extending in the direction of gravity D11 when the pair of first clamping members 151a is closed in the direction of concentration D14, as shown in FIG. 7. During a concentration process of the electric wires W12 in which the pair of first clamping members 151a is closed in the direction of concentration D14, the electric wires W12 are inserted through the through hole 151a-3 so that the electric wires W12 are clamped and held by the pair of first clamping members 151a in a loose state which allows the electric wire W12 to be moved in the direction of gravity D12.

Likewise, the pair of second clamping members 151c is plate members having a same shape, wherein the electric wire W12 are placed between the first clamping members 151a, and the first clamping members 151a are inverted to each other with respect to the electric wire W12. Each of the second clamping members 151c also includes a second indented portion 151c-1 and a second projecting portion 151c-2 that are overlapped with each other in a plate thickness direction and integrated with each other. The second indented portion 151c-1 is formed in a plate shape with a V-shaped recess. The second projecting portion 151c-2 is formed in a V-shaped projecting shape that is fitted into the second indented portion 151c-1 of the other second clamping member 151c. However, the second clamping members 151c include no notches formed therein at a deepest point in the V-shape, unlike the first clamping members 151a. During a concentration process of the electric wires W12 in which the pair of second clamping members 151c is closed in the direction of concentration D14, the electric wires W12 are therefore clamped and held more strongly by the pair of second clamping members 151c than by the pair of first clamping members 151a. Furthermore, prior to attaching the bundling members by the bundling mechanism 152 as described below, the pair of second clamping members 151c is moved in a pulling direction D15 oriented while clamping the electric wires W12, the pulling direction D15 being oriented downward along the direction of gravity D11. With this movement, the pair of second clamping members 151c pulls the electric wires W12 in the pulling direction D15 and acts for applying a tension to the electric wires W12 in the concentration position P12.

FIG. 5 shows the bundling mechanism 152 that is configured to attach a predetermined bundling member W13 to the electric wires in the concentration position P12 to bundle the electric wires gathered and brought together in the concentration position P12 by the above-described concentration mechanism 151. This bundling mechanism 152 is attached to the robotic arm 16 as also shown in FIG. 1. The bundling mechanism 152 is a taping mechanism attached to the robotic arm 16, wherein the taping mechanism is configured to be carried to a location adjacent to the concentration position P12 at the electric wires W12 by the robotic arm 16 and to wrap a tape as the bundling member W13 around the electric wires W12 in the concentration position P12. The branching target point P11a is formed by wrapping the tape.

The is an articulated mechanism attached to a ceiling portion of the outer frame 111 so as to be suspended toward the inside of the outer frame 111 from the ceiling portion. The robotic arm 16 includes the taping mechanism as the bundling mechanism 152 and the post-branching holding mechanism 17 as described below. As described above, the robotic arm 16 carries the bundling mechanism 152 to a location adjacent to the concentration position P12 after concentrating the electric wire W12 by the concentration mechanism 151. After forming the branching target point P11a by wrapping the tape by means of the bundling mechanism 152, the bundling mechanism 152 is moved away from the branching target point P11a at the concentration position P12 by the robotic arm 16 and the post-branching holding mechanism 17 is carried to a location adjacent to the concentration position P12 by the robotic arm 16.

The post-branching holding mechanism 17 is attached to the robotic arm 152 in addition to the taping mechanism as the bundling mechanism 152, wherein the post-branching holding mechanism 17 is configured to hold the electric wires W12 in the concentration position P12 with the branching target point P11a formed in the electric wires W12 by wrapping the tape. The post-branching holding mechanism 17 is configured to clamp and hold the electric wires W12 by means of a pair of holding arms 171.

The controller 18 shown in FIG. 1 is a computer device configured to control operations of the electric wire holding section 12, the connector pulling-up mechanism 13, the connector positioning mechanism 14, the branching mechanism 15, the robotic arm 16, and the post-branching holding mechanism 17 as described above. Hereinafter, a series of operations for forming a branching target point will be described which are carried out under control of the controller 18.

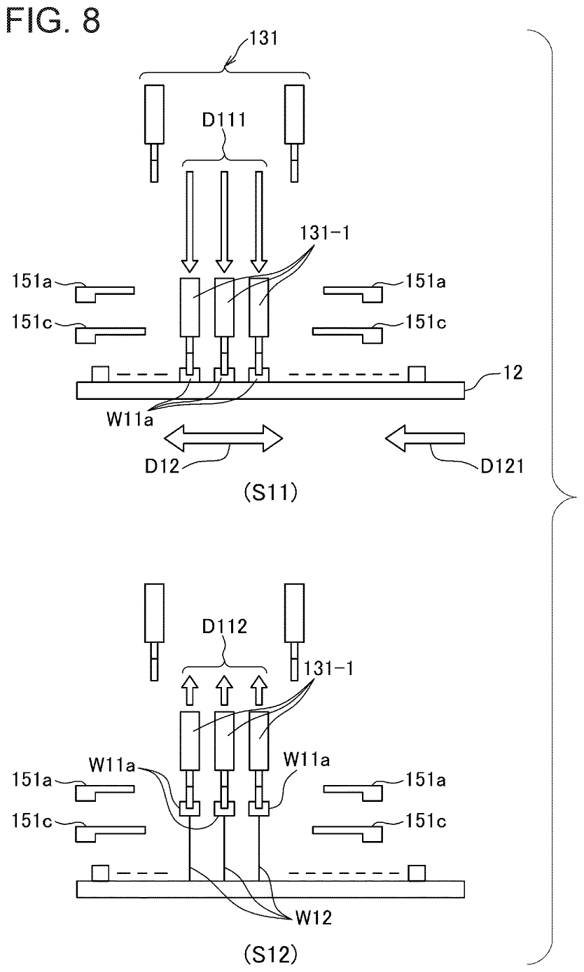

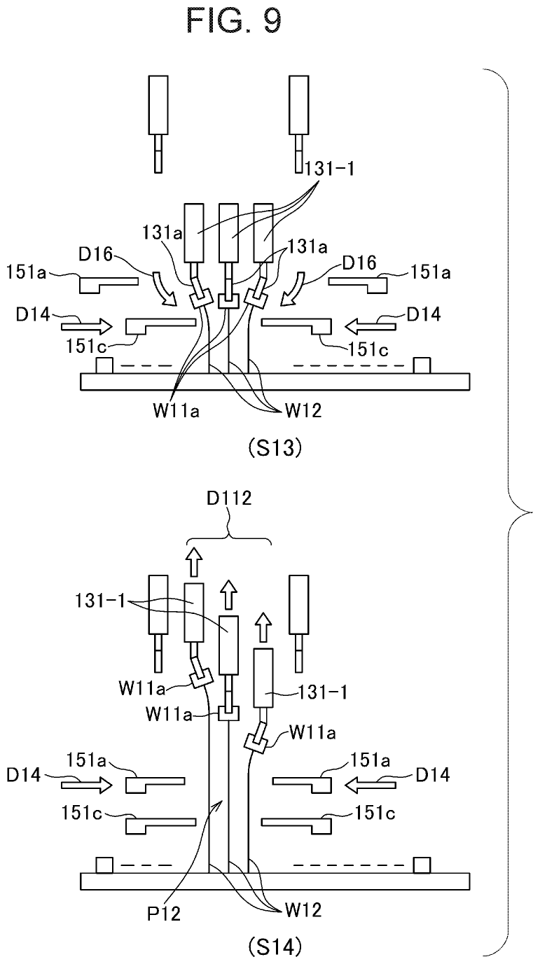

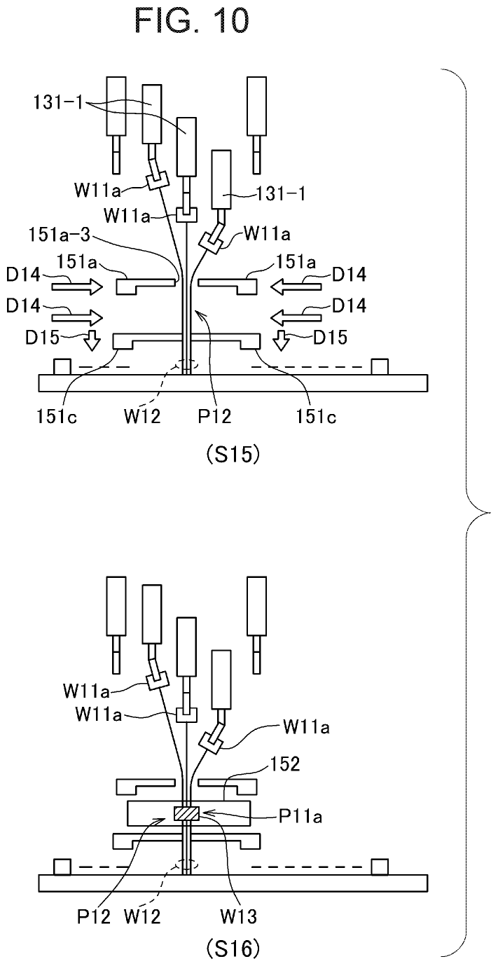

FIG. 8 schematically shows a first step S11 and a second step S12 of a series of operations for forming a branching target point which are carried out under control of the controller as shown in FIG. 1. FIG. 9 schematically shows a third step S13 and a fourth step S14 of the series of operations for forming the branching target point that follow operations as shown in FIG. 8. FIG. 10 schematically shows a fifth step S15 and a sixth step S16 of the series of operations for forming the branching target point that follow operations as shown in FIG. 9.

In the first step S11 shown in FIG. 8, the electric wire holding section 12 is first moved by sliding in a sliding direction D121 along the direction of arrangement D12. With this sliding movement, each of three target connectors W11a is positioned below one of three of the five connector chucks 131. Subsequently, the three target connector chucks 131-1 are conveyed in a downward direction D111, wherein at a destination for the conveyed three target connector chucks 131-1, they grip the three target connectors W11a. At this time, the pair of first clamping members 151a and the pair of second clamping members 151c are all in a released state.

In the next second step S12, the three target connector chucks 131-1 are conveyed by a same distance in an upward direction D112 to pull up the three target connectors W11a, wherein the distance for the conveyance in this second step S12 is smaller than the distance corresponding to the branched form. With this conveyance in this step, the electric wires W12 extending from the three target connectors W11a are positioned between the pair of second clamping members 151c. At this stage, the three target connector chucks 131-1 are positioned between the pair of first clamping members 151a.

After the second step S12, the three target connectors W11a are in a partially pulled-up state in which they have not been pulled up completely by the distance corresponding to the branched form, and in the subsequent third step S13, the pair of second clamping members 151c is moved in the direction of concentration D14 with the target connectors W11a being in the partially pulled-up state to clamp and gather the electric wires W12 together. At this time, the pair of first clamping members 151a remains fixed in position. On the other hand, the pair of second clamping members 151c is closed only to the extent that they are still opened more than in a final state as shown in FIG. 7, whereby the electric wires are gathered to be clamped loosely by the pair of second clamping members 151c. Then, the electric wires W12 are pulled in the direction of concentration D14 so that the chuck arms 131a of each target connector chuck 131-1 are rotated in a direction of rotation D16, whereby the three target connectors W11a follow the movement of the electric wires W12 being pulled and are thus tilted.

In the fourth step S14, a pulling-up process of the three target connectors W11a by conveying the three target connector chucks 131-1 in the upward direction D112 is first resumed. This conveyance of the target connector chucks 131-1 is performed individually by individual distances corresponding to the branched form. Furthermore, the above pulling-up process of the three target connectors W11a is performed in such a manner that the electric wires W12 are pulled out in the upward direction D112 through a gap between the pair of loosely closed second clamping members 151c. With this pulling-up process, part of the electric wire W12 is positioned in the concentration position P12 corresponding to the branching target point P11a. Furthermore, during this pulling-up process, the pair of first clamping members 151a is moved in the direction of concentration D14 to clamp and gather the electric wires W12 together. In the middle of the pulling-up process, the pair of first clamping members 151a gather the electric wires W12 together so as to clamp the electric wires W12 as loosely as the pair of second clamping members 151c.

The next fifth step S15 is initiated at a stage where the pulling-up process of the three target connectors W11a by conveying the three target connector chucks 131-1 has been completed and the three target connectors W11a have been pulled up by individual distances corresponding to the branched form. In this fifth step S15, the pair of first clamping members 151a is first moved in the direction of concentration D14 until they reach the state as shown in FIG. 7, wherein the pair of first clamping members 151a clamps the electric wires W12 in the loose state in which the electric wires W12 are inserted through the through hole 151a-3. At the same time, the pair of second clamping members 151c is moved until they reach the state as shown in FIG. 7 so that the pair of second clamping members 151c clamps and holds the electric wires W12. Furthermore, the pair of second clamping members 151c is moved in the pulling direction D15 oriented downward along the direction of gravity to apply a tension to the electric wires W12 in the concentration position P12. The electric wires W12 are then moved slightly in the pulling direction D15 through the through hole 151a-3.

In the following sixth step S16, the taping mechanism as the bundling mechanism 152 is carried by the robotic arm 16 to a location adjacent to the concentration position P12 of the electric wires W12. At the destination for carrying the bundling mechanism 152, this bundling mechanism 152 then wraps a tape as the bundling member W13 around the electric wire W12 in the concentration position P12. For the electric wires W12 extending from the three target connectors W11a, one branching target point P11a is formed by wrapping the tape.

After the branching target point P11a is formed in this manner, the bundling mechanism 152 is moved away from the branching target point P11a in the concentration position P12, and at this time, the post-branching holding mechanism 17 is carried to a position adjacent to the concentration position P12. The post-branching holding mechanism 17 clamps and holds the electric wires W12 in the concentration position P12, wherein the three target connector chucks 131-1 release the three target connectors W11a. After this, the post-branching holding mechanism 17 may carry the branched electric wires W12 to a predetermined storage location and place the branched electric wires W12 there, or carry the branched electric wires W12 to a bundling location to bundle them with one or more other electric wires W12 for forming another branch junction point P11.

The harness branching apparatus 1 according to the embodiment as described above is configured in such a manner that the unbranched connector-combined electric wire W1a is held by the electric wire holding section 12 by holding the plurality of connectors W11 aligned horizontally in line in the direction of arrangement D12 intersecting the direction of gravity D11. At this time, the unbranched separated electric wires W12 are suspended from the respective connectors W11 in the direction of gravity D11. For the connector-combined electric wire W1a in such a state, the plurality of target connectors W11a of the connector-combined electric wire W1a is gripped and pulled up by the plurality of target connector chucks 131-1 associated with the branching process, and the branch junction point P11 for the connector-combined electric wire W1a is formed by bundling the electric wires W12 by the branching mechanism 15. In this manner, the harness branching apparatus 1 as described above enables the branch junction point P11 defining the branched form of the wire harness to be formed without performing a routing process on a wiring board.

Furthermore, according to the present embodiment, each of the connector chucks 131 is configured to hold one connector W11 in the direction of gripping D13 to be rotatable around the axis of rotation X11 extending along the direction of gripping D13, wherein the direction of gripping D13 intersects both the direction of arrangement D12 and the direction of gravity D11. When the electric wires W12 extending from the gripped connectors W11 are pulled in the direction of concentration D14 by the branching mechanism 15, the connectors W11 can follow the pulling movement to be tilted by rotatably holding the connectors W11. In addition, the tilted connectors W11 may result in reduction of load applied to root portions of the electric wires W12 facing the connectors W11.

Here, according to the present embodiment, the chuck conveying mechanism 132 includes the plurality of conveyance holding sections 132a and the driving section 132b. This configuration enables downward and upward movements of the connector chucks 131 accompanying the connector pulling-up process to be performed precisely by conveying the connector chucks 131 by means of the conveyance holding sections 132a which have received a driving force from the driving section 132b.

Furthermore, the present embodiment provides the connector positioning mechanism 14 configured to move the electric wire holding section 12 slidingly in order to position each of the plurality of target connectors W11a below one of the plurality of target connector chucks 131-1. This configuration enables the target connectors W11a to be gripped and pulled up precisely by the target connector chucks 131-1 by positioning the target connectors W11a associated with the branching process below the target connector chucks 131-1 that are responsible for pulling up the target connectors W11a.

Furthermore, the branching mechanism 15 according to the present embodiment includes the concentration mechanism 151 and the bundling mechanism 152, the concentration mechanism 151 being configured to gather the electric wires W12 to be brought together in the concentration position P12, wherein the bundling mechanism 152 is configured to bundle the in the concentration position P12 by attaching the bundling member W13 to the electric wires W12. According to this configuration, the electric wires W12 are gathered to be brought together in the concentration position P12 before attaching the bundling member W13 to the electric wires W12, which enables attachment of the bundling member W13 to be with good workability.

Furthermore, the concentration mechanism 151 according to the present embodiment includes the pair of first clamping members 151a and the pair of second clamping members 151c, the pair of first clamping members 151a being configured to clamp and hold the electric wires W12 in the loose state above the concentration position P12, wherein the pair of second clamping members 151c is configured to gather the electric wires W12 below the concentration position P12. After the end of the pulling-up process of the target connectors W11a, the pair of second clamping members 151c applies a tension to the electric wires W12 in the concentration position P12 by moving the pair of second clamping members 151c downward prior to attaching the bundling member W13 by the bundling mechanism 152. With this configuration, portions of the electric wires W12 are straightened which extend between two holding positions for holding the electric wires W12 by the first clamping members 151a and the second clamping members 151c respectively and include the concentration position P12. The electric wires W12 that are thus straightened enable attachment of the bundling member W13 thereto to be performed with still better workability, which is therefore preferable.

Furthermore, the pair of first clamping members 151a according to the present embodiment is configured to gather the electric wires W12 to clamp them more loosely in the middle of the pulling-up process of the target connector W11a than in the loose state, wherein after the end of the pulling-up process, the pair of first clamping members 151a is configured to clamp and hold the electric wires W12 in the loose state. In addition, the pair of second clamping members 151c gathers the electric wires W12 together to clamp them as loosely as the pair of first clamping members 151a in the middle of the pulling-up process. Then, the pair of second clamping members 151c clamps the electric wires W12 after the end of the pulling-up process, wherein the pair of second clamping members 151c moves the electric wires W12 downward to apply a tension to the electric wires W12. With this configuration, the pulling-up process of the target connector W11a can be performed in parallel to holding the electric wires W12 by the first clamping members 151a and the second clamping members 151c, which enables the operation time to be reduced. Moreover, the tension applied to the electric wires W12 after the end of the pulling-up process of the target connectors W11a may suppress undesired situations, such as offset of the electric wires W12 due to a force applied for the subsequent attachment of the bundling member W13 which may possibly push the electric wires W12.

Moreover, the bundling mechanism 152 according to the present embodiment is the taping mechanism configured to be carried to a location adjacent to the concentration position P12 by the predetermined robotic arm 16 and to wrap the tape as the bundling member W13 around the electric wires W12. This configuration enables the bundling mechanism 152 to be positioned to a work location by the robotic arm 16. In addition, using the taping mechanism as the bundling mechanism 152 enables the electric wires W12 to be effectively bundled with the tape.

Furthermore, according to the present embodiment, the post-branching holding mechanism 17 is attached to the robotic arm 16 together with the taping mechanism as the bundling mechanism 152. This configuration enables the following processes to be performed for the connector-combined electric wire W1b with the branching target point P11a formed: the post-branching holding mechanism 17 may carry the branched electric wires W12 to a predetermined storage location and place the branched electric wires W12 there, or carry the branched electric wires W12 to a bundling location to bundle them with one or more other electric wires W12 for forming another branching target point P11a.

It is to be noted that the above embodiment merely shows a representative form of harness branching apparatus. The harness branching apparatus is not limited thereto, but may be modified and implemented in various manners.

For example, the above embodiment shows the unbranched and branched connector-combined electric wire W1a and W1b as schematically shown in FIG. 2, as examples of the unbranched and branched connector-combined electric wire. However, the unbranched and branched connector-combined electric wire is not limited thereto, but any specific branched form and/or the like may be used.

As an example of the harness branching apparatus, the above embodiment further shows the harness branching apparatus 1 including the outer frame 111 having a rectangular parallelepiped appearance and the inner frame 112 constructed inside the outer frame 111, the outer frame 111 being formed e.g. by combined metal squared beams. However, the harness branching apparatus is not limited thereto, but any specific frame structure, appearance geometry and/or the like may be selected.

As an example of the harness branching apparatus, the above embodiment further shows one controller 18, wherein operations of various components are performed under control of the controller 18. However, the harness branching apparatus is not limited thereto, but it may include no specific controller, wherein operations of the various components may be implemented e.g. by switch operations by an operator. In the case of the harness branching apparatus including one or more controllers, control of the operations of the various components may be divided for a plurality of controllers, or a controller may be operated under control of a server device connected to the controller through a predetermined network.

As an example of chuck conveying mechanism, the above embodiment further shows the chuck conveying mechanism 132 including the plurality of conveyance holding sections 132a and the driving section 132b. Furthermore, conveyor belts are employed for the conveyance holding sections 132a. However, the chuck conveying mechanism is not limited thereto, but any specific conveying configuration may be used. However, the chuck conveying mechanism 132 including the plurality of conveyance holding sections 132a and the driving section 132b enables downward and upward movements of the connector chucks 131 to be performed precisely, as described above.

As an example of the harness branching apparatus, the above embodiment further shows the harness branching apparatus 1 including the connector positioning mechanism 14 configured to move the electric wire holding section 12 slidingly to position the plurality of target connectors W11a. However, the harness branching apparatus is not limited thereto, but it may be configured in such a manner that holding positions of the plurality of connectors including the target connectors may be non-adjustable. However, the target connectors W11a may be gripped and pulled up precisely by the connector positioning mechanism 14 moving the electric wire holding section 12 slidingly and thus positioning the target connector W11a, as described above.

As an example of the branching mechanism, the above embodiment further shows the branching mechanism 15 including the concentration mechanism 151 and the bundling mechanism 152 for the electric wire W12. However, the branching mechanism is not limited thereto, but any specific configuration may be used for forming the branching target point. However, the branching mechanism 15 including the concentration mechanism 151 and the bundling mechanism 152 for the electric wire W12 enables attachment of the bundling member W13 to be performed with good workability, as described above.

As an example of the concentration mechanism, the above embodiment further shows t concentration mechanism 151 including the pair of first clamping members 151a and the pair of second clamping members 151c that are configured to be arranged above and below the concentration position P12 respectively. Furthermore, the pair of second clamping members 151c is responsible for applying a tension to the electric wires W12 after the end of the pulling-up process of the connectors. However, the concentration mechanism is not limited thereto, but any mechanism configuration may be employed which gathers the electric wires in the direction of concentration. However, the concentration mechanism 151 including the pair of first clamping members 151a and the pair of second clamping members 151c in which a tension is applied by the pair of second clamping members 151c enables attachment of the bundling member W13 to be performed with still better workability.

As an example of the pair of first clamping members, the above embodiment further shows the pair of first clamping members 151a configured to gather the electric wires W12 so as to clamp them more loosely in the middle of the pulling-up process of the connectors than in the loose state, wherein after the end of the pulling-up process, the pair of first clamping members 151a is configured to clamp and hold the electric wires W12 in the loose state. In addition, as an example of the pair of second clamping members, the above embodiment shows the pair of second clamping members 151c configured to gather the electric wires W12 to clamp them loosely in the middle of the pulling-up process of the connectors, wherein after the end of the pulling-up process, the pair of second clamping members 151c is configured to clamp the electric wires W12 and apply a tension thereto. However, the pair of first clamping members and the pair of second clamping members are not limited thereto, but any timing may be selected for initiating operations of the clamping members for pulling up the target connectors W11a. However, the above operations of the pair of first clamping members 151a and the pair of second clamping members 151c may reduce the operation time, wherein subsequent application of a tension to the electric wires W12 may suppress offset of the electric wires W12 during attachment of the bundling member W13, as described above.

As an example of the bundling mechanism, the above embodiment further shows the bundling mechanism 152 for which the taping mechanism carried by the robotic arm 16 is employed. However, the bundling mechanism is not limited thereto, but a mechanism may be possible which is capable of being positioned to a position for attachment of the bundling member without a robotic arm. Moreover, the mechanism itself is not limited to a taping mechanism, but a mechanism may be possible which is attach e.g. a cable tie and/or clipping component as the bundling member. However, the bundling mechanism 152 can be positioned precisely to a work location by using the taping mechanism carried by the robotic arm 16 so that the electric wires W12 can be effectively bundled with the tape, as described above.

As an example of the harness branching apparatus, the above embodiment further shows the harness branching apparatus 1 including the post-branching holding mechanism 17 that is attached to the robotic arm 16 in addition to the taping mechanism as the bundling mechanism 152. However, the harness branching apparatus is not limited thereto, but it may include no such specific post-branching holding mechanism. However, the post-branching holding mechanism 17 may enable various handling operations for the branched electric wires W12, as described above.

### Reference Signs List

1 Harness branching apparatus
11 Frame
12 Electric wire holding section
13 Connector pulling-up mechanism
14 Connector positioning mechanism
15 Branching mechanism
16 Robotic arm
17 Post-branching holding mechanism
18 Controller
111 Outer frame
112 Inner frame
112a Slide rail
121 Holding section main body
122 Holding chucks
122a Arms
131 Connector chucks
131-1 Target connector chucks
131a Chuck arms
131b Arm driving section
131b-1 Intercoupling members
131b-2 Driving source
131c Conveyance held section
132 Chuck conveying mechanism
132a Conveyance holding sections
132b Driving section
151 Concentration mechanism
151a First clamping members
151a-1 First indented portion
151a-2 First projecting portion
151a-3 Through hole
151a-4 Recess
151b First clamping driving sections
151c Second clamping members
151c-1 Second intended portion
151c-2 Second projecting portion
151d Second clamping driving sections
152 Bundling mechanism
171 Holding arms
D11 Direction of gravity
D111 Downward direction
D112 Upward direction
D12 Direction of arrangement
D121 Sliding direction
D13 Direction of gripping
D14 Direction of concentration
D15 Pulling direction
P11 branch junction points
P11a branching target point
P12 Concentration position
S11 First step
S12 Second step
S13 Third step
S14 Fourth step
S15 Fifth step
S16 Sixth step
W1a Unbranched connector-combined electric wire
W1b Branched connector-combined electric wire
W11 Connectors
W11a Target connectors
W11a-1 Gripped connector
W12 electric wires
W13 bundling member
X11 Axis of rotation

What is claimed is:

1. A harness branching apparatus comprising:
an electric wire holding section configured to hold one or more connector-combined electric wires in an unbranched state, the one or more connector-combined electric wires including a plurality of connectors and electric wires interconnected between the plurality of connectors,
wherein the one or more connector-combined electric wires have been produced in a pre-process for producing a wire harness having a branched form with one or more branch junction points,
wherein the electric wire holding section is configured to hold the plurality of connectors aligned horizontally in line in a direction of arrangement for holding the one or more connector-combined electric wires in the unbranched state,
wherein the direction of arrangement intersects a direction of gravity;
a connector pulling-up mechanism configured to pull up a plurality of target connectors connected to ends of electric wires leading to a branching target point, upward from the electric wire holding section along the direction of gravity by a distance corresponding to the branched form and to hold the plurality of target connectors, the plurality of target connectors being included the plurality of connectors,
wherein the branching target point is one of the branch junction points that are intended to define the branched form when the wire harness is completed; and
a branching mechanism configured to gather and bundle electric wires suspended from the plurality of target connectors respectively to form the branching target point,
wherein the electric wires suspended from the plurality of target connectors are gathered in a direction of concentration so that the electric wires are brought together in the direction of gravity in a concentration position corresponding to the branching target point, and
wherein the direction of concentration extends along the direction of arrangement,
wherein the connector pulling-up mechanism includes:
a predetermined number of connector chucks aligned horizontally in line in the direction of arrangement above the electric wire holding section along the direction of gravity, each of the connector chucks being movable along the direction of gravity,
wherein the predetermined number is larger than one,
wherein each of the connector chucks is configured to hold one gripped connector in a direction of gripping to be rotatable around an axis of rotation extending along the direction of gripping,
wherein the direction of gripping intersects both the direction of arrangement and the direction of gravity; and
a chuck conveying mechanism configured to hold the connector chucks aligned horizontally in line in the direction of arrangement so that the connector chucks are individually conveyable in the direction of gravity,
wherein the connector chucks include a plurality of target connector chucks each of which is associated with one of the plurality of target connectors,
wherein the chuck conveying mechanism is further configured to move the plurality of target connector chucks downward to allow each of the plurality of target connector chucks to grip an associated one of the plurality of target connectors and to move each of the plurality of target connectors upward by a distance corresponding to the branched form.

2. The harness branching apparatus according to claim 1,
wherein the chuck conveying mechanism includes:
a plurality of conveyance holding sections, each of the plurality of conveyance holding sections being configured to hold one of the connector chucks so that the connector chucks is conveyable in the direction of gravity,
a driving section configured to provide a driving force to the plurality of conveyance holding sections to cause the plurality of conveyance holding sections to convey the connector chucks in the direction of gravity.

3. The harness branching apparatus according to claim 1,
wherein the electric wire holding section is slidable along the direction of arrangement,
wherein the harness branching apparatus further comprises a connector positioning mechanism configured to move the electric wire holding section slidingly along the direction of arrangement prior to downward movement of the plurality of target connector chucks to the plurality of target connectors in order to position each of the plurality of target connectors below one of the plurality of target connector chucks.

4. The harness branching apparatus according to claim 1,
wherein the branching mechanism includes:
a concentration mechanism configured to initiate gathering the electric wires in the direction of concentration at a point of time between start and end of a pulling-up process of the plurality of target connectors by the connector pulling-up mechanism so that the electric wires are brought together in the concentration position; and
a bundling mechanism configured to attach a predetermined bundling member to the electric wires in the concentration position to bundle the electric wires gathered and brought together in the concentration position by the concentration mechanism.

5. The harness branching apparatus according to claim 4,
wherein the concentration mechanism includes:
a pair of first clamping members arranged above the concentration position in the direction of gravity, the pair of first clamping members being configured to gather the electric wires together so as to clamp the electric wires in the direction of concentration,
wherein when concentrating the electric wires, the pair of first clamping members is configured to clamp and hold the electric wires in a loose state which allows the electric wires to be moved in the direction of gravity; and
a pair of second clamping members arranged below the concentration position the direction of gravity, the pair of second clamping members being configured to gather the electric wires together so as to clamp the electric wires in the direction of concentration,
wherein after completing the pulling-up process of the plurality of target connectors and prior to attaching the bundling member by the bundling mechanism, the pair of second clamping members is configured to move the electric wires downward along the direction of gravity while clamping the electric wires to apply tension to the electric wires in the concentration position.

6. The harness branching apparatus according to claim 5,
wherein during the pulling-up process of the plurality of target connectors, the pair of first c lamping members is configured to gather the electric wires so as to clamp the electric wires more loosely than in the loose state,
wherein after completing the pulling-up process of the plurality of target connectors, the pair of first clamping members is configured to clamp the electric wires in the loose state,
wherein during the pulling-up process of the plurality of target connectors, the pair of second clamping members is configured to gather the electric wires so as to clamp the electric wires as loosely as the pair of first clamping members, and
wherein after completing the pulling-up process of the plurality of target connectors, the pair of second clamping members is configured to clamp the electric wires and move the electric wires downward in the direction of gravity in order to apply the tension to the electric wires.

7. The harness branching apparatus according to claim 4,
wherein the bundling mechanism is a taping mechanism attached to a predetermined robotic arm,
wherein the taping mechanism is configured to be carried to a location adjacent to the concentration position at the electric wires by the robotic arm and to wrap a tape as the bundling member around the electric wires in the concentration position.

8. The harness branching apparatus according to claim 7, further comprising a post-branching holding mechanism attached to the robotic arm in addition to the taping mechanism,
wherein the post-branching holding mechanism is configured to hold the electric wires with the branching target point formed therein by wrapping the tape.
